(19) United States
(12) Patent Application Publication
(10) Pub. No.: US 2014/0062612 A1
(43) Pub. Date: Mar. 6, 2014

(54) SIGNAL TRANSMISSION CIRCUIT HAVING CROSSTALK CANCELLATION UNIT

(71) Applicants: SK HYNIX INC., Gyeonggi-do (KR); INDUSTRY-UNIVERSITY COOPERATION FOUNDATION HANYANG UNIVERSITY, Seoul (KR)

(72) Inventors: Chun-Seok JEONG, Gyeonggi-do (KR); Young-Hoon KIM, Seoul (KR); Chang-Sik YOO, Seoul (KR)

(73) Assignees: Industry-University Cooperation Foundation Hanyang University, Seoul (KR); SK hynix Inc., Gyeonggi-do (KR)

(21) Appl. No.: 13/718,885

(22) Filed: Dec. 18, 2012

(30) Foreign Application Priority Data
Aug. 31, 2012 (KR) 10-2012-0096397

(51) Int. Cl. H01P 1/20

(52) U.S. Cl. CPC H01P 1/20
USPC 333/12

(57) ABSTRACT

A signal transmission circuit may include a main driving unit configured to drive a first signal transmission line with given driving force in response to a first input signal, and a crosstalk cancellation unit configured to differentiate a signal transferred through a second signal transmission line, which is adjacent to the first signal transmission line, and incorporate a differentiated value into the first signal transmission line.

### CROSS-REFERENCE TO RELATED APPLICATIONS

The present application claims priority of Korean Patent Application No. 10-2012-0096397, filed on Aug. 31, 2012, which is incorporated herein by reference in its entirety.

### BACKGROUND

1. Field

Exemplary embodiments of the present invention relate to semiconductor design technology, and more particularly, to a signal transmission circuit including a plurality of signal transmission lines and a crosstalk cancellation unit.

2. Description of the Related Art

In general, a plurality of signal transmission lines (or channels) is disposed within a semiconductor device, such as double data rate synchronous DRAM (DDR SDRAM). The signal transmission line transfers a given signal to a desired block through a signal transmission circuit. With the development of process technology, the width of the signal transmission line is gradually reduced, and thus an interval (or pitch) between the signal transmission lines is also reduced. The development of the process technology has provided a base on which the size of the semiconductor device may be significantly reduced, but generates new concerns that have not been present before the reduction in size of the semiconductor device.

Recently, one of the most significant concerns occurring due to a reduction in the interval between the signal transmission lines is a signal distortion due to crosstalk.

FIG. 1 is a circuit diagram illustrating a conventional signal transmission circuit.

Referring to FIG. 1, the signal transmission circuit includes a main driver 110 and a crosstalk equalizing driver 120.

The main driver 110 drives a first signal transmission line DQ1_OUT in a given voltage level in response to a first input signal DQ1. Furthermore, the crosstalk equalizing driver 120 compensates for the signal distortion of the first signal transmission line DQ1_OUT and compensates for the first signal transmission line DQ1_OUT in response to second to fourth input signals DQ2, DQ3, and DQ4 transferred through second to fourth signal transmission lines that are disposed close to the first signal transmission line DQ1_OUT.

As illustrated in FIG. 1, the second to fourth input signals DQ2, DQ3, and DQ4 and second to fourth input signals DQ2B, DQ3B, DQ4B, that is, the inverted and delayed signals of the second to fourth input signals DQ2, DQ3, and DQ4, respectively, in order to compensate for the signal distortion of the first signal transmission line DQ1_OUT. That is, the crosstalk equalizing driver 120 incorporates the second to fourth input signals DQ2, DQ3, and DQ4 and a compensation value corresponding to each of the second to fourth input signals DQ2B, DQ3B, and DQ4B, that is, the inverted and delayed signals of the second to fourth input signals DQ2, DQ3, and DQ4, respectively, into the first signal transmission line DQ1_OUT.

In the state in which the first input signal DQ1 and the second input signal DQ2 are transferred through adjacent signal transmission lines, when the second input signal DQ2 shifts from a logic low level to a logic high level, signal distortion from a logic high level to a logic low level occurs in the first input signal DQ1 on a reception circuit side to which the first and the second input signals DQ1 and DQ2 are transferred. In contrast, when the second input signal DQ2 shifts from a logic high level to a logic low level, signal distortion from a logic low level to a logic high level occurs in the first input signal DQ1 on the reception circuit side.

Accordingly, a transmission circuit includes a circuit for compensating for this signal distortion, such as the crosstalk equalizing driver 120. That is, the crosstalk equalizing driver 120 adds a compensation value corresponding to each of the second to fourth input signals DQ2, DQ3, and DQ4 and the second to fourth input signals DQ2B, DQ3B, and DQ4B, to the first input signal DQ1. In other words, in order for the reception circuit side to receive the same signal as the first input signal DQ1, a transmission circuit has to transfer a signal in which the compensation value is added to the first input signal DQ1 through the first signal transmission line DQ1_OUT.

For reference, control codes EN<1:5> have been set at a given value corresponding to the compensation value.

Meanwhile, in the circuit configuration of FIG. 1, the driving force of the crosstalk equalizing driver 120 has to increase in order to compensate for greater signal distortion. In this case, the impedance of the transmission circuit is varied. That is, the driving force of the crosstalk equalizing driver 120 and the impedance of the transmission circuit are controlled in conjunction with each other. For this reason, it is difficult to control any one of the driving force of the crosstalk equalizing driver 120 and the impedance of the transmission circuit. This means that control of the driving force of the crosstalk equalizing driver 120 and the impedance of the transmission circuit is very limited.

For example, in the state in which the main driver 110 has given driving force, if the driving force of the crosstalk equalizing driver 120 is set high in order to increase a compensation value, the impedance of the transmission circuit is varied. Accordingly, the driving force of the main driver 110 must be set low for the purpose of impedance matching. In this case, it is difficult for the reception circuit to determine an input signal transferred by the main driver 110 because the intensity of the input signal is reduced.

As a result, in order to properly control the driving force of the main driver 110 and the driving force of the crosstalk equalizing driver 120, the driving force of the main driver 110 and the driving force of the crosstalk equalizing driver 120 must be controlled very limitedly and carefully.

### SUMMARY

Exemplary embodiments of the present invention are directed to provide a signal transmission circuit capable of a compensation value setting operation on crosstalk irrespective of an impedance setting operation.

In accordance with an embodiment of the present invention, a signal transmission circuit may include a main driving unit configured to drive a first signal transmission line with given driving force in response to a first input signal, and a crosstalk cancellation unit configured to differentiate a signal transferred through a second signal transmission line, which is adjacent to the first signal transmission line, and incorporate a differentiated value into the first signal transmission line.

In accordance with another embodiment of the present invention, a signal transmission circuit may include a first main driving unit configured to drive a first signal transmission line in response to a first input signal, a second main driving unit configured to drive a second signal transmission line, which is adjacent to the first signal transmission line, in response to a second input signal, a compensating driving unit configured to receive a signal transferred through the second signal transmission line, and a capacitor configured to incorporate a given capacitance into an output signal of the compensating driving unit and add the capacitance-incorporated signal to the first signal transmission line.

In accordance with another embodiment of the present invention, a first signal transmission line, a second signal transmission line adjacent to the first signal transmission line, a third signal transmission line adjacent to the second signal transmission line, a first to a third main driving units configured to drive the first to third signal transmission lines in response to a first to a third input signals, respectively, a first and a second compensating driving units configured to receive the second and third input signal, and a first and a second capacitors configured to incorporate corresponding given capacitances into output signals of the first and second compensating driving units, respectively, and add the capacitance-incorporated signals to the first signal transmission line.

In accordance with another embodiment of the present invention, a method of operating a signal transmission system may include controlling the impedance of each of a plurality of signal transmission lines by performing a first data training operation on the plurality of signal transmission lines, and controlling a compensation value for crosstalk of each of the plurality of signal transmission lines by performing a second data training operation on the plurality of signal transmission lines.

In accordance with another embodiment of the present invention, a main driving unit configured to drive a first signal transmission line with a first driving force in response to a first input signal, and a crosstalk cancellation unit configured to incorporate a part of information contained in a second input signal, transferred through a second signal transmission line, adjacent to the first signal transmission line, into the first signal transmission line for each given time.

In accordance with another embodiment of the present invention, a signal transmission circuit may include a first main driving unit configured to drive a first signal transmission line in response to a first signal, a second main driving unit configured to drive a second signal transmission line in response to a second signal, a first crosstalk cancellation unit configured to receive the second signal and add a second compensation value, corresponding to the second signal, to the first signal transmission line, and a second crosstalk cancellation unit configured to receive the first signal and add a first compensation value, corresponding to the first signal, to the second signal transmission line.

### BRIEF DESCRIPTION OF THE DRAWINGS

FIG. 1 is a circuit diagram illustrating a conventional signal transmission circuit.

FIG. 2 is a waveform diagram for explaining a crosstalk cancellation operation in accordance with embodiments of the present invention.

FIG. 3 is a block diagram illustrating a signal transmission circuit in accordance with an embodiment of the present invention.

FIG. 4 is a detailed diagram of the crosstalk cancellation unit shown in FIG. 3.

FIG. 5 is a block diagram illustrating a signal transmission circuit in accordance with another embodiment of the present invention.

FIG. 6 is a flowchart illustrating a method of operating a system including the signal transmission circuit in accordance with another embodiment of the present invention.

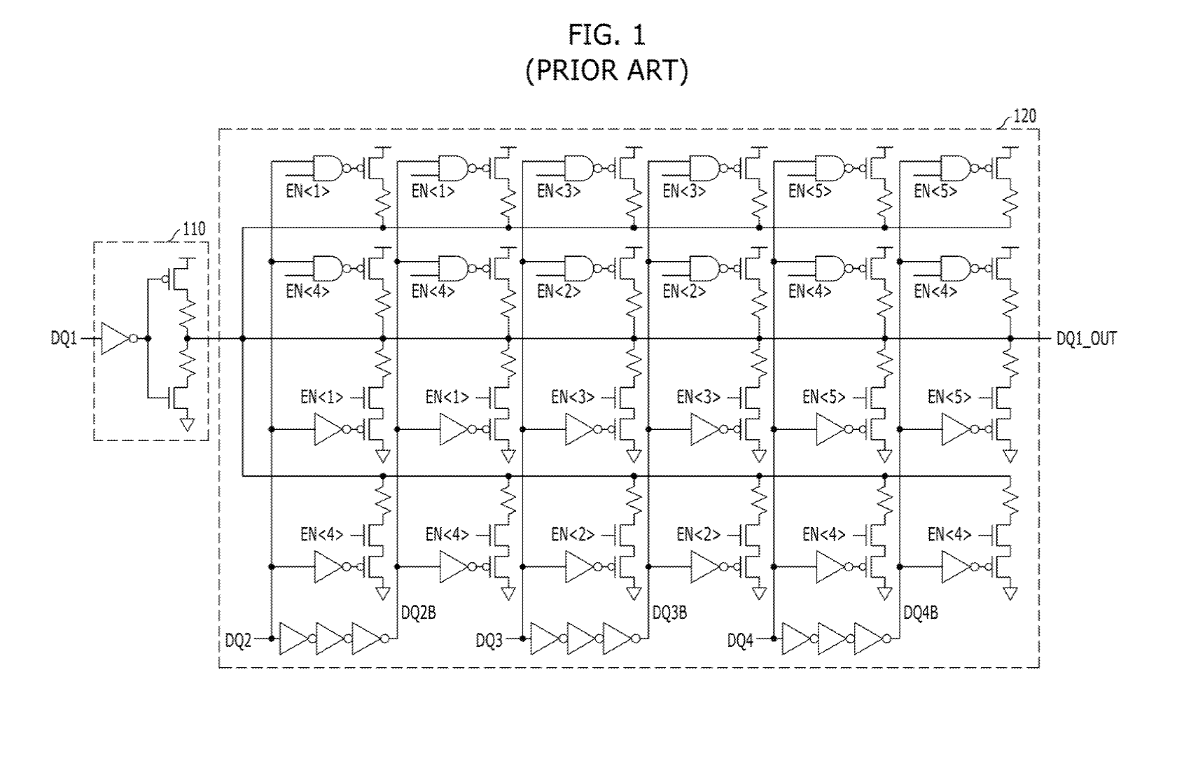

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. In this specification, a singular form may include a plural form as long as it is not specifically mentioned in a sentence.

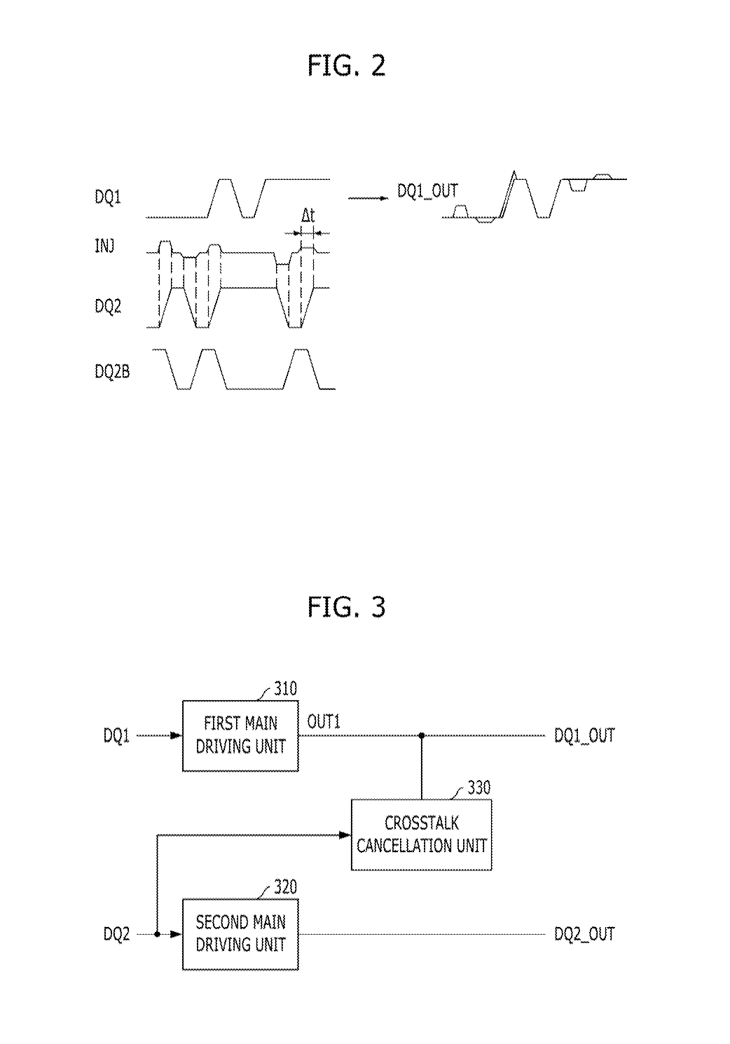

FIG. 2 is a waveform diagram for explaining a crosstalk cancellation operation in accordance with embodiments of the present invention. First and second input signals DQ1 and DQ2 are described as an example, for convenience of description, and a second input signal DQ2B, that is, the inverted and delayed signal of the second input signal DQ2, is not used in the embodiments of the present invention.

FIG. 2 shows the first input signal DQ1, a compensation value IN), and the second input signal DQ2. The compensation value INJ means a value that is incorporated into the first signal transmission line DQ1_OUT for every given unit time Δt. As will be described later, the compensation value IN) is a part of information contained in the second input signal DQ2, and it may include a value obtained by differentiating the second input signal DQ2, for example. Furthermore, a crosstalk cancellation unit 330 to be described with reference to FIG. 3 performs the above operation.

FIG. 3 is a block diagram illustrating a signal transmission circuit in accordance with an embodiment of the present invention.

Referring to FIG. 3, the signal transmission circuit includes a first main driving unit 310, a second main driving unit 320, and the crosstalk cancellation unit 330.

The first main driving unit 310 drives a first signal transmission line DQ1_OUT with given driving force in response to the first input signal DQ1, and the second main driving unit 320 drives a second signal transmission line DQ2_OUT with given driving force in response to the second input signal DQ2. Furthermore, the crosstalk cancellation unit 330 differentiates the second input signal DQ2 and incorporates a differentiated value into the first signal transmission line DQ1_OUT.

The signal transmission circuit in accordance with an embodiment of the present invention includes the crosstalk cancellation unit 330 for compensating for signal distortion occurring in the first signal transmission line DQ1_OUT due to the second input signal DQ2 that is transferred through the second signal transmission line DQ2_OUT disposed close to the first signal transmission line DQ1_OUT. Here, the crosstalk cancellation unit 330 differentiates the second input signal DQ2 and incorporates a differentiated value into the first signal transmission line DQ1_OUT. That is, the output signal OUT1 of the first main driving unit 310 to which the value obtained by differentiating the second input signal DQ2 has been added is transferred to the first signal transmission line DQ1_OUT.

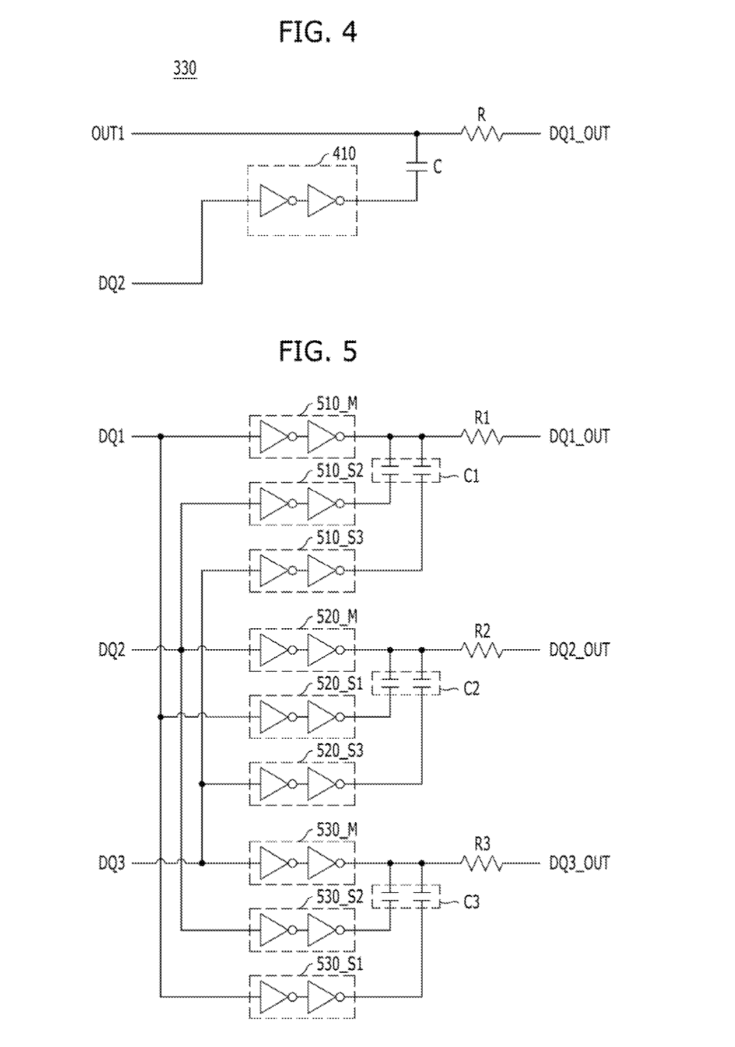

FIG. 4 is a detailed diagram illustrating the crosstalk cancellation unit 330 shown in FIG. 3.

Referring to FIG. 4, the crosstalk cancellation unit 330 includes a compensating driving unit 410, a capacitor C, and a resistor R.

The compensating driving unit 410 receives and outputs the second input signal DQ2. The capacitor C incorporates a given capacitance into the output signal of the compensating driving unit 410 and adds the capacitance-incorporated signal to the first signal transmission line DQ1_OUT. Furthermore, the resistor R is placed on the first signal transmission line DQ1_OUT.

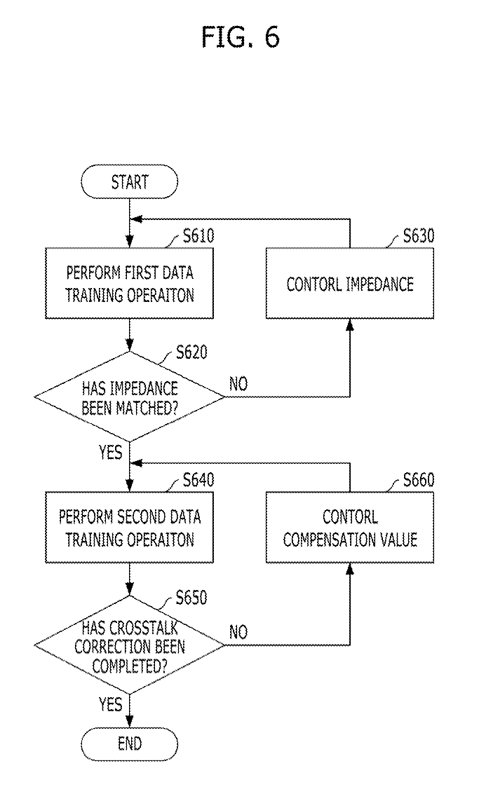

In an embodiment of the present invention, the crosstalk cancellation unit 330 may have a filter structure. The filter structure may include a low-pass filter, a high-pass filter or a band-pass filter. An embodiment of the present invention illustrates an example in which the crosstalk cancellation unit 330 for differentiating the second input signal DQ2 and incorporating a differentiated value into the first signal transmission line DQ1_OUT is formed of a high-pass filter. Here, the capacitor C has given capacitance and may have capacitance controlled in response to the control signal as will be described later. Contents related to control of the capacitance will be described later with reference to FIG. 6.

Meanwhile, the driving force of the compensating driving unit 410 corresponds to each given unit time Δt of FIG. 2. That is, the signal transmission circuit in accordance with an embodiment of the present invention may vary the given unit time Δt by changing the driving force of the compensating driving unit 410.

FIG. 5 is a block diagram illustrating a signal transmission circuit in accordance with another embodiment of the present invention. FIG. 5 illustrates an example of a configuration for transferring first to third input signals DQ1, DQ2, and DQ3.

Referring to FIG. 5, the signal transmission circuit includes first to third main driving units 510_M, 520_M, and 530_M, first compensating driving units 510_S2 and 510_S3, second compensating driving units 520_S1 and 520_S3, third compensating driving units 530_S2 and 530_S1, first to third capacitors C1, C2, and C3, and first to third resistors R1, R2, and R3.

The first to third main driving units 510_M, 520_M, and 530_M drive first to third signal transmission lines DQ1_OUT, DQ2_OUT, and DQ3_OUT, respectively, with given driving force in response to the first to third input signals DQ1, DQ2, and DQ3, respectively. The first compensating driving units 510_S2 and 510_S3 correspond to the first signal transmission line DQ1_OUT and receive the second and the third input signals DQ2 and DQ3. The second compensating driving units 520_S1 and 520_S3 correspond to the second signal transmission line DQ2_OUT and receive the first and the third input signals DQ1 and DQ3. The third compensating driving units 530_S2 and 530_S1 correspond to the third signal transmission line DQ3_OUT and receive the second and the first input signals DQ2 and DQ1. The first to third capacitors C1, C2, and C3 incorporates respective given capacitances into the respective output signals of the first to third compensating driving units 510_S2 and 510_S3, 520_S1 and 520_S3, and 530_S1 and 530_S2, and add respective capacitance-incorporated signals to the first to third signal transmission lines DQ1_OUT, DQ2_OUT, and DQ3_OUT, respectively. Furthermore, the first to third resistors R1, R2, and R3 are placed on the first to third signal transmission lines DQ1_OUT, DQ2_OUT, and DQ3_OUT, respectively.

Assuming that signal distortion occurring in the first signal transmission line DQ1_OUT is compensated for by the second and the third input signals DQ2 and DQ3, the first signal transmission line DQ1_OUT becomes a ‘target signal transmission line’ for performing a compensation operation on the signal distortion. Accordingly, in an embodiment of the present invention, the second and the third input signals DQ2 and DQ3 are differentiated, and a differentiated value is incorporated into the first signal transmission line DQ1_OUT, that is, the target signal transmission line, in order to compensate for the signal distortion occurring in the first signal transmission line DQ1_OUT.

FIG. 6 is a flowchart illustrating a method of operating a system including the signal transmission circuit in accordance with another embodiment of the present invention.

Referring to FIG. 6, the method of operating a system including the signal transmission circuit (hereinafter referred to as a ‘signal transmission system’) includes performing a first data training operation at step S610 determining whether impedance matching has been completed or not at step S620, controlling impedance at step S630, performing a second data training operation at step S640, determining whether crosstalk correction has been completed or not at step S650, and controlling a compensation value at step S660.

First, the step S610 of performing the first data training operation the step S620 of determining whether impedance matching has been completed or not, and the step S630 of controlling impedance are included in a step of controlling the impedance of the plurality of signal transmission lines.

The step of controlling the impedance is described below.

At step S610 current impedance is detected by performing the first data training operation. At step S620, whether current impedance is desired impedance or not is determined. If, as a result of the determination at step S620, it is determined that current impedance is not desired impedance, the current impedance is controlled at step S630, and the process returns to the step S610. If, as a result of the determination at step S620, it is determined that current impedance is desired impedance, the process proceeds to the step S640.

Meanwhile, the step S640 of performing the second data training operation, the step S650 of determining whether crosstalk correction has been completed or not, and the step S660 of controlling a compensation value are included in a step for controlling a compensation value for the crosstalk of each of the plurality of signal transmission lines.

The step for controlling the compensation value for crosstalk is described below.

At step S640, a compensation value for current crosstalk is detected by performing the second data training operation. At step S650, whether the compensation value for the current crosstalk is a desired value or not is determined. If, as a result of the determination at step S650, it is determined that the compensation value for current crosstalk is not a desired value, the compensation value for the current crosstalk is controlled at step S660 and the process returns to the step S640. If, as a result of the determination at step S650, it is determined that the compensation value for current crosstalk is a desired value, the reset operation of the signal transmission system is terminated.

In particular, the compensation value controlled at the step S660 may become the capacitance of the capacitor shown in FIGS. 3 to 5. That is, capacitance may be controlled through the data training operations, and the controlled capacitance is incorporated into a crosstalk compensation operation.

The signal transmission system in accordance with an embodiment of the present invention may perform an impedance setting operation and a compensation value setting operation for crosstalk. For reference, the impedance of a transmission circuit is not changed when controlling a compensation value for crosstalk because capacitance may be controlled in the compensation value setting operation for crosstalk. Accordingly, in accordance with an embodiment of the present invention, impedance may be set in an optimal state, and a compensation value for crosstalk may be set in an optimal state irrespective of the impedance.

The signal transmission circuit in accordance with an embodiment of the present invention may set impedance and a compensation values in an optimal state because the compensation value setting operation for crosstalk may be performed irrespective of the impedance setting operation.

Furthermore, there is an advantage in that a stable signal transmission may be secured because both impedance and a compensation value for crosstalk are set in an optimal state.

While the present invention has been described with respect to the specific embodiments, it will be apparent to those skilled in the art that various changes and modifications may be made without departing from the spirit and scope of the invention as defined in the following claims.

What is claimed is:

1. A signal transmission circuit, comprising:
a main driving unit configured to drive a first signal transmission line with given driving force in response to a first input signal; and
a crosstalk cancellation unit configured to differentiate a signal transferred through a second signal transmission line, which is adjacent to the first signal transmission line, and incorporate a differentiated value into the first signal transmission line.

2. The signal transmission circuit of claim wherein the crosstalk cancellation unit has a filter structure.

3. A signal transmission circuit, comprising:
a first main driving unit configured to drive a first signal transmission line in response to a first input signal;
a second main driving unit configured to drive a second signal transmission line, which is adjacent to the first signal transmission line, in response to a second input signal;
a compensating driving unit configured to receive a signal transferred through the second signal transmission line; and
a capacitor configured to incorporate a given capacitance into an output signal of the compensating driving unit and add the capacitance-incorporated signal to the first signal transmission line.

4. The signal transmission circuit of claim 3, further comprising a resistor on the first signal transmission line.

5. The signal transmission circuit of claim 3, wherein the given capacitance of the capacitor is controlled in response to a control signal.

6. A signal transmission circuit, comprising:
a first signal transmission line;
a second signal transmission line adjacent to the first signal transmission line;
a third signal transmission line adjacent to the second signal transmission line;
a first to a third main driving units configured to drive the first to third signal transmission lines in response to a first to a third input signals respectively;
a first and a second compensating driving units configured to receive the second and third input signal; and
a first and second capacitors configured to incorporate corresponding given capacitances into output signals of the first and second compensating driving units, respectively, and add the capacitance-incorporated signals to the first signal transmission line.

7. The signal transmission circuit of claim 6, further comprising a resistor on the first signal transmission line.

8. The signal transmission circuit of claim 6, wherein the given capacitances of the first and second capacitors are controlled in response to a first and a second control signals, respectively.

9. A method of operating a signal transmission system, comprising:
controlling impedance of each of a plurality of signal transmission lines by performing a first data training operation on the plurality of signal transmission lines; and
controlling a compensation value for crosstalk of each of the plurality of signal transmission lines by performing a second data training operation on the plurality of signal transmission lines.

10. The method of claim 9, further comprising incorporating the compensation value, set by the controlling of a compensation value for crosstalk of each of the plurality of signal transmission lines by performing a second data training operation on the plurality of signal transmission lines, into a corresponding signal transmission line and sending a signal through the plurality of signal transmission lines.

11. The method of claim 10, wherein the sending of a signal through the plurality of signal transmission lines comprises:
sending a first signal through a first signal transmission line of the plurality of signal transmission lines;
sending a second signal through a second signal transmission line of the plurality of signal transmission lines; and
differentiating the second signal and adding a differentiated value to the first signal transmission line.

12. The method of claim 10, wherein the compensation value comprises capacitance incorporated into the corresponding signal transmission line of the plurality of signal transmission lines.

13. The method of claim 12, wherein the sending of a signal through the plurality of signal transmission lines comprises:
sending a first signal through a first signal transmission line of the plurality of signal transmission lines;
sending a second signal through a second signal transmission line of the plurality of signal transmission lines; and
adding the capacitance to a first signal transmission line by incorporating the capacitance into the second signal.

14. The method of claim 9, wherein the controlling of impedance of each of a plurality of signal transmission lines by performing a first data training operation on the plurality of signal transmission lines and the controlling of a compensation value for crosstalk of each of the plurality of signal transmission lines by performing a second data training operation on the plurality of signal transmission lines have different operation periods.

15. The method of claim 9, wherein the controlling of impedance of each of a plurality of signal transmission lines by performing a first data training operation on the plurality of signal transmission lines comprises:
detecting the impedance by performing the first data training operation; and
controlling the impedance based on a result of the detection.

16. The method of claim 9, wherein the controlling of a compensation value for crosstalk of each of the plurality of signal transmission lines by performing a second data training operation on the plurality of signal transmission lines comprises:
detecting the compensation value by performing the second data training operation; and
controlling the compensation value based on a result of the detection.

17. A signal transmission circuit, comprising:
a main driving unit configured to drive a first signal transmission line with a first driving force in response to a first input signal; and
a crosstalk cancellation unit configured to incorporate a part of information contained in a second input signal, transferred through a second signal transmission line, adjacent to the first signal transmission line, into the first signal transmission line for each given time.

18. The signal transmission circuit of claim 17, wherein the crosstalk cancellation unit comprises:
a compensating driving unit configured to drive the second input signal with a second driving force; and
a capacitor configured to incorporate a given capacitance into an output signal of the compensating driving unit and add the capacitance-incorporated signal to the first signal transmission line.

19. The signal transmission circuit of claim 18, wherein the given unit time is varied in response to the second driving force.

20. A signal transmission circuit, comprising:
a first main driving unit configured to drive a first signal transmission line in response to a first signal;
a second main driving unit configured to drive a second signal transmission line in response to a second signal;
a first crosstalk cancellation unit configured to receive the second signal and add a second compensation value, corresponding to the second signal, to the first signal transmission line; and
a second crosstalk cancellation unit configured to receive the first signal and add a first compensation value, corresponding to the first signal, to the second signal transmission line.
